(19) United States
(12) Patent Application Publication
(10) Pub. No.: US 2023/0298155 A1
(43) Pub. Date: Sep. 21, 2023

(54) INFORMATION PROCESSING APPARATUS AND INFORMATION PROCESSING METHOD

(71) Applicant: KABUSHIKI KAISHA TOSHIBA, Tokyo (JP)

(72) Inventor: Hideo Nishiuchi, Yokohama Kanagawa (JP)

(21) Appl. No.: 18/183,450

(22) Filed: Mar. 14, 2023

(30) Foreign Application Priority Data
Mar. 18, 2022 (JP) 2022-044106
Jan. 17, 2023 (JP) 2023-005292

(51) Int. Cl. G06T 7/00; G06V 10/25; G06V 10/56; G06V 10/70

(52) U.S. Cl. CPC G06T 7/0008; G06V 10/25; G06V 10/56; G06V 10/70; G06T 2207/20081; G06T 2207/30152

(57) ABSTRACT

In an embodiment, an information processing apparatus relating to soldering of a component onto a substrate is provided. The information processing apparatus includes a determination unit determining, using a machine learning model that outputs an inspection result of a post-reflow inspection from an input of image data based on one or more pre-reflow images, whether or not defectiveness will occur in the post-reflow inspection from the image data based on the pre-reflow images acquired in real time.

### CROSS-REFERENCE TO RELATED APPLICATIONS

This application is based upon and claims the benefit of priority from Japanese Patent Application No. 2022-044106, filed Mar. 18, 2022; and No. 2023-005292, filed Jan. 17, 2023, the entire contents of all of which are incorporated herein by reference.

### FIELD

Embodiments described herein relate generally to an information processing apparatus and an information processing method.

### BACKGROUND

In joining a component to a board such as a printed wiring board and a printed board by means of soldering, room-temperature solder and the component are mounted in this order onto the board, which is a substrate. By performing a reflow process with the solder and the component mounted on the board, the solder is melted, and the component is joined to the board by means of soldering. After printed boards obtained by joining a component onto a board by means of soldering are manufactured as products, inspection such as a visual inspection and an electrical test are performed on the manufactured printed boards after the reflow process, to prevent defective products from being distributed to the market.

When products such as printed boards are manufactured by means of soldering, as described above, it is demanded that defectiveness in the product be detected prior to the reflow process, from the viewpoint of suppressing both an increase in loss of members caused by occurrence of defective products and an increase in the number of steps required to repair the defective products. That is, it is demanded that, prior to joining of a component to a substrate by means of a reflow process, defectiveness in the products to be manufactured be detected.

### BRIEF DESCRIPTION OF THE DRAWINGS

FIG. 1 is a schematic diagram showing an example of a manufacturing system according to a first embodiment, in which printed boards are manufactured as products.

FIG. 2 is a block diagram schematically showing a configuration of an information processing apparatus of the manufacturing system according to the first embodiment.

FIG. 3 is a schematic diagram showing an example of processing of the image processing unit and the determination unit of the information processing apparatus according to the first embodiment.

FIG. 4 is a flowchart schematically showing an example of image processing performed by the image processing unit of the information processing apparatus according to the first embodiment.

FIG. 5 is a flowchart schematically showing another example of the image processing different from FIG. 4, performed by the image processing unit of the information processing apparatus according to the first embodiment.

FIG. 6 is a schematic diagram showing an example of a machine learning model used for determination by the determination unit of the information processing apparatus according to the first embodiment.

FIG. 7 is a flowchart schematically showing an example of a machine learning model generation process performed by the learning model generation unit of the information processing apparatus according to the first embodiment.

FIG. 8 is a block diagram schematically showing a configuration of an information processing apparatus of a manufacturing system according to a second embodiment.

FIG. 9 is a flowchart schematically showing an example of a defective cause identification process performed by a cause identification unit of the information processing apparatus according to the second embodiment.

FIG. 10 is a schematic diagram illustrating an example of an extraction process of a node with a high level of contribution to the defectiveness determination performed by the cause identification unit of the information processing apparatus according to the second embodiment.

FIG. 11 is a schematic diagram illustrating an example of a reporting process of a portion identified as the cause of the defectiveness in the image data, performed by the cause identification unit of the information processing apparatus according to the second embodiment.

FIG. 12 is a schematic diagram showing a manufacturing system according to a third embodiment as an example of a manufacturing system in which a semiconductor device is manufactured as a product.

FIG. 13 is a schematic diagram showing an example of image data generated by image processing in the image processing unit of the information processing apparatus according to the third embodiment.

### DETAILED DESCRIPTION

According to an embodiment, an information processing apparatus relating to soldering of a component onto a substrate is provided. The information processing apparatus includes a determination unit configured to determine, using a machine learning model that outputs an inspection result of a post-reflow inspection from an input of image data based on one or more pre-reflow images, whether or not defectiveness will occur in the post-reflow inspection from the image data based on the pre-reflow images acquired in real time.

Hereinafter, embodiments, etc. will be described with reference to the accompanying drawings.

### First Embodiment

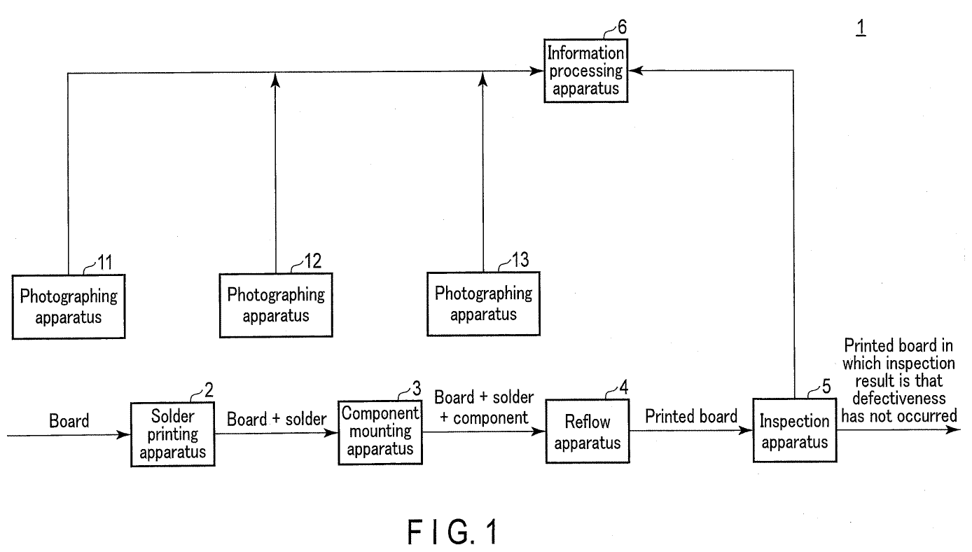

A first embodiment will be described as an example of the embodiment. FIG. 1 shows a manufacturing system 1 according to the first embodiment, as an example of a manufacturing system in which printed boards are manufactured as products. As shown in FIG. 1, etc., the manufacturing system 1 includes a solder printing apparatus 2, a component mounting apparatus 3, a reflow apparatus 4, an inspection apparatus 5, and an information processing apparatus 6. In the manufacturing system 1, a manufacturing line of printed boards, which are products, is formed, and the solder printing apparatus 2, the component mounting apparatus 3, the reflow apparatus 4, and the inspection apparatus 5 are arranged in this order from the upstream side in the manufacturing line.

In the manufacturing line, boards, which are substrates, are conveyed to the solder printing apparatus 2. The board may be a printed wiring board, or a printed board (printed circuit board) in which a component such as a chip component already attached onto a printed wiring board. The solder printing apparatus 2 mounts solder onto a board by, for example, printing solder to a pad, a land, etc. formed on a surface of the board. In one example, solder mounting onto a board may be performed by printing solder onto a surface of a component already attached to a printed board, which is a substrate. In the solder printing apparatus 2, room-temperature solder is mounted onto a board, namely, solder is mounted onto a board in a non-melted state. A method of mounting solder onto a board is not limited to printing. In one example, solder mounting onto a board may be performed by either dispensing (applying) solder thereto or mounting a solder sheet thereon.

The boards on which solder is mounted are conveyed to the component mounting apparatus 3. The component mounting apparatus 3 mounts a component to be newly attached onto the board. Examples of the component to be mounted on the board include, for example, chip components, IC packages, etc. Through the mounting of the component, the solder is interposed between the board and the component. The boards on which the solder and the component are mounted are conveyed to the reflow apparatus 4. The reflow apparatus 4 performs soldering by means of a reflow process. Through the reflow process, the solder mounted on the board is melted, and a newly mounted component is joined to the board. Thereby, a printed board with the mounted component attached to the board is formed. In one example, a newly mounted component is joined to a pad, a land, etc. formed on a surface of the board by means of soldering. In another example, a newly mounted component is joined to a component already mounted on a board.

A printed board manufactured as a product, namely, a printed board obtained by joining a component to a board by means of a reflow process in the reflow apparatus 4 is conveyed to the inspection apparatus 5. The inspection apparatus 5 inspects the manufactured printed board, and determines whether the manufactured printed boards are defective or non-defective. Through the inspection by the inspection apparatus 5, only printed boards determined to be non-defective are distributed to the market as distribution products. The inspection apparatus 5 performs, for example, a visual inspection and an electricity test on the manufactured printed boards. In the visual inspection, images of a printed board obtained by joining a component to a board by means of a reflow process are acquired by photography, etc., and whether or not the manufactured printed board is defective is determined based on the acquired images of the printed board. In the electricity test, whether or not the manufactured printed boards are defective is determined by, for example, allowing electricity to flow through the printed boards and measuring an amount of the electricity using a tester. The inspection apparatus 5 sends information indicating an inspection result obtained by an actually performed inspection to the information processing apparatus 6.

In the manufacturing system 1, photographing apparatuses 11 to 13 are provided. Each of the photographing apparatus 11 to 13 is, for example, a camera or a video camera. The photographing apparatus 11 is arranged on an upstream side relative to the solder printing apparatus 2, and photographs an image of only a board. The photographing apparatus 12 is arranged between the solder printing apparatus 2 and the component mounting apparatus 3, and photographs an image of the board on which only solder is mounted. The photographing apparatus 13 is arranged between the component mounting apparatus 3 and the reflow apparatus 4, and photographs an image of the board on which the solder and the component are mounted. Thereby, in the manufacturing system 1, three types of images, namely, an image of only a board, an image of the board on which only solder is mounted, and an image of the board on which the solder and a component are mounted are photographed by the photographing apparatuses 11 to 13 as images prior to a reflow process to be performed by the reflow apparatus 4.

Each of the photographing apparatuses 11 to 13 sends the photographed image (image data) to the information processing apparatus 6. Thus, the information processing apparatus 6 acquires the above-described three types of images as pre-reflow images. Each of the photographing apparatuses 11 to 13 performs photography in real time every time a single board is conveyed as a substrate to the manufacturing line. Thus, every time a single board is conveyed to the manufacturing line, the information processing apparatus 6 acquires, in real time, three types of pre-reflow images photographed by the photographing apparatuses 11 to 13.

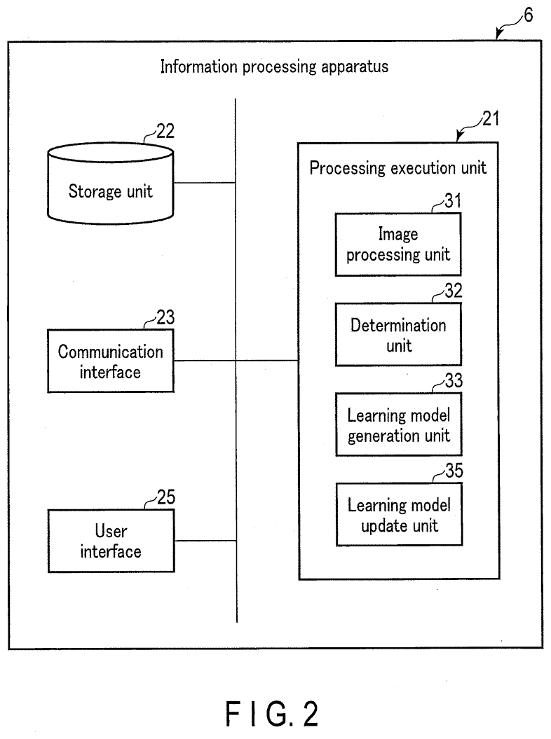

FIG. 2 shows an example of a configuration of the information processing apparatus 6 according to the present embodiment. As shown in FIG. 2, the information processing apparatus 6 includes a processing execution unit 21, a storage unit 22, a communication interface 23, and a user interface 25. The processing execution unit 21 includes an image processing unit 31, a determination unit 32, a learning model generation unit 33, and a learning model update unit 35. Each of the image processing unit 31, the determination unit 32, the learning model generation unit 33, and the learning model update unit 35 performs part of the processing performed by the processing execution unit 21.

In one example, the information processing apparatus 6 is configured of a computer, etc., and a processor or an integrated circuit of a computer functions as the processing execution unit 21. A processor or an integrated circuit of a computer includes one of a central processing unit (CPU), an application-specific integrated circuit (ASIC), a graphics processing unit (GPU), a microcomputer, a field-programmable gate array (FPGA), a digital signal processor (DSP), etc. The number of integrated circuits, etc. included in a computer that functions as the information processing apparatus 6 may be either one or more than one.

In a computer that functions as the information processing apparatus 6, a storage medium (non-transitory storage medium) of the computer functions as the storage unit 22. The storage medium may include an auxiliary storage in addition to a primary storage such as a memory. Examples of the storage medium include magnetic disks, optical disks (CD-ROMs, CD-Rs, DVDs, etc.), magneto-optical disks (MOs, etc.), semiconductor memories, etc. The computer that functions as the information processing apparatus 6 may include only one storage medium, etc., or a plurality of storage media.

In a computer that functions as the information processing apparatus 6, a processor or an integrated circuit executes programs, etc. stored in the storage medium, etc., and thereby processing by the processing execution unit 21, to be described below, is performed. In one example, in a computer that functions as the information processing apparatus 6, programs to be executed by a processor, etc. may be stored in, for example, a computer (server) connected via a network such as the Internet or a server in cloud environment. In this case, the processor downloads the programs via the network. In one example, the information processing apparatus 6 is configured of a plurality of computers that are separate from one another. In this case, processing by the processing execution unit 21, to be described below, is performed by processors, integrated circuits, etc. of the computers.

In one example, the information processing apparatus 6 is configured of a server of a cloud environment. The infrastructure of the cloud environment is configured of a virtual processor such as a virtual CPU and a cloud memory. In the server of the cloud environment of which the information processing apparatus 6 is configured, a virtual processor, etc. functions as the processing execution unit 21, and processing by the processing execution unit 21, to be described below, is performed by the virtual processor, etc. The cloud memory functions as the storage unit 22.

In the information processing apparatus 6, the communication interface 23 is configured of an interface that accesses external devices such as the inspection apparatus 5 and the photographing apparatuses 11 to 13. The information processing apparatus 6 is capable of communicating, either in a wired or wireless manner, with an external device via the communication interface 23. Therefore, in the information processing apparatus 6, information indicating an inspection result in the inspection apparatus 5 and images photographed by the photographing apparatuses 11 to 13 are acquired via the communication interface 23.

In the information processing apparatus 6, various types of operations, etc. are input by a user, etc. of the manufacturing system 1 at the user interface 25. At the user interface 25, one of a button, a switch, a touch panel, etc. is provided as an operation member to which an operation is input by a user, etc. of the manufacturing system 1. In the user interface 25, various types of information are reported to a user, etc. of the manufacturing system 1. The reporting of the information is performed by, for example, screen display, audio broadcasting, etc. In one example, the user interface 25 is provided as an external device of the information processing apparatus 6, and is provided separately from the computer, etc. that configures the information processing apparatus 6.

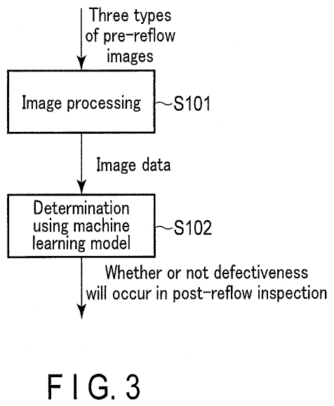

Hereinafter, processing performed by the processing execution unit 21 will be described. FIG. 3 shows an example of processing by the image processing unit 31 and the determination unit 32. As shown in FIG. 3, etc., the image processing unit 31 performs image processing as pre-processing of the processing at the determination unit 32 (S101). The image processing unit 31 performs image processing using three types of pre-reflow images, namely, an image of only the board, an image of the board on which only solder is mounted, and an image of the board on which the solder and a component are mounted. By performing the image processing, the image processing unit 31 generates, as image data used for the processing at the determination unit 32, image data based on the three types of pre-reflow images. Also, the image processing unit 31 generates, every time a single board is conveyed to the manufacturing line, image data based on the three types of pre-reflow images acquired in real time.

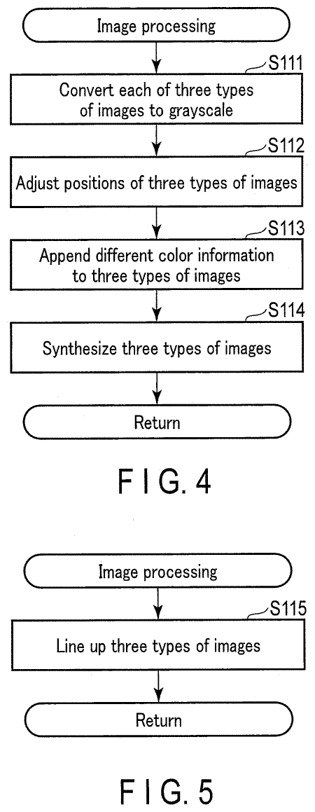

FIG. 4 shows an example of the image processing by the image processing unit 31. The processing of the example of FIG. 4 is performed every time a single board is conveyed to the manufacturing line, namely, three types of pre-reflow images are acquired (photographed) in real time. Upon starting of the processing in FIG. 4, the image processing unit 31 converts each of the three types of images to grayscale (S111). The image processing unit 31 adjusts positions of the three types of images with respect to one another (S112). Thereby, position gaps among the three types of images are corrected.

The image processing unit 31 appends different color information to the grayscale-converted three types of images (S113). At this time, in one example, blue color information is appended to the image of only the board, green color information is appended to the image of the board on which only the solder is mounted, and red color information is appended to the image of the board on which the solder and the component are mounted. The image processing unit 31 synthesizes the three types of images to which different color information is appended (S114). Thereby, image data configured of a synthesis image of the three types of images is generated as image data used in processing by the determination unit 32. Therefore, in the example of FIG. 4, image data used in the processing at the determination unit 32 is generated by adjusting the positions of the three types of images and appending different color information to the three types of images, and then synthesizing the three types of images.

FIG. 5 shows another example of image processing by the image processing unit 31 different from that in FIG. 4. The processing of the example of FIG. 5 is similarly performed every time a single board is conveyed to the manufacturing line, namely, three types of pre-reflow images are acquired (photographed) in real time. Upon starting of the processing in FIG. 4, the image processing unit 31 lines up the three types of images (S115). Thereby, image data in which the three types of images are lined up is generated as image data used in the processing by the determination unit 32. Thus, in the example of FIG. 5, the image data used in the processing at the determination unit 32 is configured of the three types of images that are lined up.

The storage unit 22 stores a machine learning model generated (constructed) as will be described below. As shown in FIG. 3, etc., the determination unit 32 determines, using the machine learning model, whether or not defectiveness will occur in a post-reflow inspection to be performed at the inspection apparatus 5, based on the above-described image data generated by the image processing unit 31 (S102). That is, the determination unit 32 determines whether or not defectiveness will occur in a post-reflow inspection, based on image data based on the three types of pre-reflow images acquired in real time. The determination unit 32 causes the machine learning model to input the image data generated by the image processing unit 31. The determination unit 32 causes the machine learning model to output information indicating whether or not defectiveness will occur in the inspection, and makes a result of the output from the machine learning model a determination result regarding whether or not defectiveness will occur in the inspection.

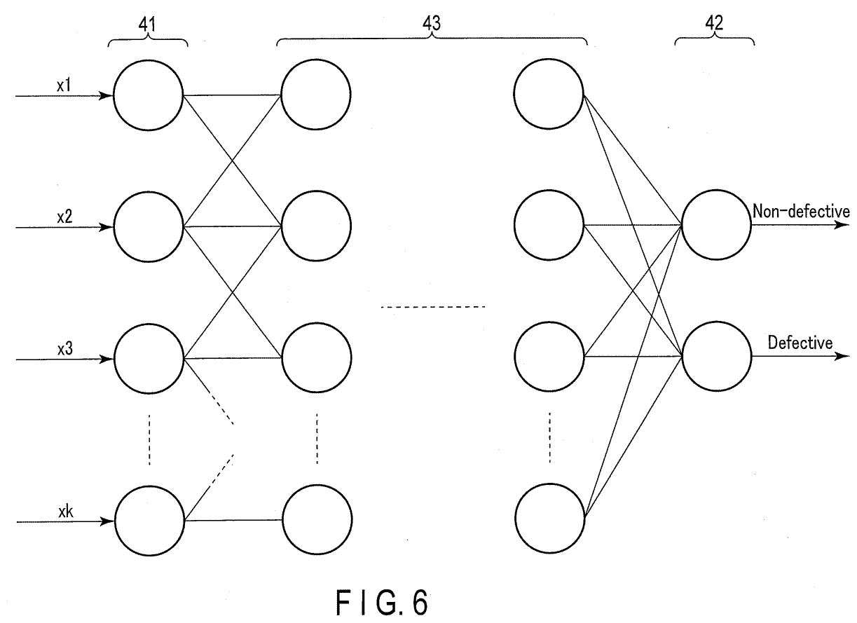

FIG. 6 shows an example of a machine learning model used for determination by the determination unit 32. As shown in FIG. 6, etc., the machine learning model is configured of an input layer 41, an output layer 42, and an intermediate layer (hidden layer) 43 between the input layer 41 and the output layer 42. If the above-described image data is input to the machine learning model, pixel-by-pixel pixel information, such as RGB values, is input to the input layer 41 regarding to all the images configuring the image data. If, for example, a synthesis image is generated as image data, as in the example of FIG. 4, etc., pixel-by-pixel pixel information of the synthesis image is input to the input layer 41. If image data in which three types of images are lined up, as in the example of FIG. 5, etc. is generated, pixel-by-pixel pixel information of all the three types of images that are lined up is input to the input layer 41.

In the machine learning model of the example of FIG. 6, etc., the input layer 41 is configured of a number of nodes identical to the total number of pixels in all the images configuring the image data. In the example of FIG. 6, etc., the total number of pixels in all the images configuring the image data is k, and pixel information x1 to xk is input to the input layer 41. In the machine learning model of the example of FIG. 6, etc., the output layer 42 is configured of a node that outputs information indicating that defectiveness will not occur in the inspection, and a node that outputs information indicating that defectiveness will occur in the inspection.

Also, the intermediate layer 43 is configured of a plurality of convolutional layers, a plurality of pooling layers, a fully connected layer, etc. In the convolutional layers, one or more feature parts in the image are extracted by performing a filtering process on each pixel. In the pooling layers, the image is reduced in size, while maintaining the feature parts of the image. Through the processing at the pooling layers, position gaps of the feature parts in the image configuring the image data input to the machine learning model are absorbed. In the intermediate layer 43, features of the image are recognized through processing at the convolutional layers and the pooling layers. In the fully connected layer, the image data of which the feature parts have been recognized at the convolutional layers and the pooling layers is converted into one-dimensional data. Through the above-described processing, the feature parts in the image are recognized in the intermediate layer 43 of the machine learning model, and the recognized feature parts are converted into information used for determining whether or not defectiveness will occur in the inspection.

The machine learning model used for determination by the determination unit 32 is generated (constructed) by the learning model generation unit 33. In the generation of the machine learning model, learning data configured of a large number of data sets is used. In each of the data sets of the learning data, image data based on the above-described three types of pre-reflow images is shown for a printed board on which an inspection has been previously performed. The image data shown in each of the data sets is generated using the three types of pre-reflow images in a manner similar to, for example, either the example of FIG. 4 or the example of FIG. 5.

In each of the data sets of the learning data, an inspection result of a post-reflow inspection that has been actually performed is shown for a printed board on which an inspection has been previously performed. In each of the data sets, the above-described image data and inspection result regarding the printed board previously inspected in the manufacturing system 1 may be shown; alternatively, the above-described image data and inspection result may be shown for the previously inspected printed board in another manufacturing system with a configuration similar to the manufacturing system 1. Since the learning data is configured as described above, in each of the large number of data sets of the learning data, image data based on pre-reflow images and an inspection result of a post-reflow inspection that has been actually performed are associated with each other, for the previously inspected printed board. It is to be noted that the inspected printed boards differ among the large number of data sets.

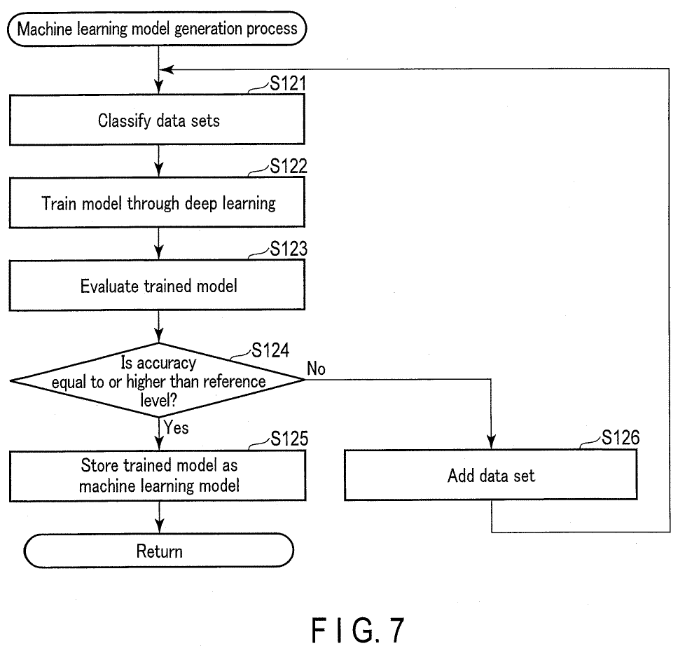

FIG. 7 shows an example of a generation process (construction process) of a machine learning model by the learning model generation unit 33. Upon starting of the processing in FIG. 7, the learning model generation unit 33 classifies a large number of data sets of the learning data into training data sets and evaluation data sets (S121). In one example, a large number of data sets are classified in such a manner that the ratio of the number of the training data sets to the number of the evaluation data sets becomes 9.

The learning model generation unit 33 trains a model through deep learning using the training data sets of the learning model (S122). At this time, a neural network, for example, is trained as a model. The model is trained through supervised learning in which an inspection result shown in each of the training data sets is given as a correct answer. Through deep learning, the model learns features included in the image data of the training data set, and learns, for example, features in the image data that cause defectiveness indicated in an inspection result.

Upon completing the learning using the training data set, the learning model generation unit 33 evaluates a trained model using the evaluation data set (S123). In the evaluation of the model, image data based on the pre-reflow image is input to the trained model, regarding to each of the evaluation data sets. A comparison is made between an output result from the trained model and an inspection result of an inspection that has been actually performed, regarding to each of the evaluation data sets. An accuracy of the output result from the model relative to the inspection result of the actually performed inspection is calculated, as an index for evaluating the trained model.

Upon completing the evaluation using the evaluation data set, the learning model generation unit 33 determines whether or not the accuracy calculated as an index for evaluating the trained model is equal to or higher than a reference level (S124). In one example, the accuracy is determined to be equal to or higher than a reference level based on the accuracy being equal to or higher than 90%. If the accuracy is equal to or higher than the reference level (S124-Yes), the learning model generation unit 33 stores, as the above-described machine learning model used for determination by the determination unit 32, a trained model in the storage unit 22 (S125).

If the accuracy is lower than the reference level (S124-No), the learning model generation unit 33 adds a data set to the learning data (S126). The processing returns to S121, and the learning model generation unit 33 sequentially performs the processing at S121 and thereafter. Thereby, learning of the model using the added data set and the evaluation of the model using the added data set are performed. It is to be noted that the learning model generation unit 33 need not be provided in the information processing apparatus 6. In one example, a generation process (construction process) of the above-described machine learning model is performed by a computer, etc. separate from the information processing apparatus 6.

In the information processing apparatus 6, the learning model update unit 35 retrains the machine learning model, and thereby updates the machine learning model. The learning model update unit 35 stores the updated machine learning model in the storage unit 22. In one example, every time a situation occurs in which a determination result by the determination unit 32 differs from an inspection result of an inspection that has been actually performed, the machine learning model is retrained. In another example, the machine learning model is retrained based on an accuracy of a determination result by the determination unit 32 relative to an inspection result of an actually performed inspection being lower than a reference level. In this case, based on, for example, the above-described accuracy being lower than 90%, the accuracy is determined to be lower than the reference level. In another example, regardless of the above-described accuracy, etc., the machine learning model is periodically retrained at predetermined intervals.

Updating of the machine learning model is performed in a manner similar to the generating of the machine learning model. That is, in updating of the machine learning model, a large number of data sets are used, and in each of the used data sets, image data based on pre-reflow images and an inspection result of a post-reflow inspection that has been actually performed are associated with each other, for the printed boards that have been inspected. The learning model update unit 35 classifies the data sets into training data sets and evaluation data sets, and the machine learning model is retrained using a training data set, in a manner similar to the learning of the model in the generation of the machine learning model. Upon completing the retraining, the retrained machine learning model is evaluated in a manner similar to the evaluation of the trained model in the generation of the machine learning model.

As a result of the above-described updating of the machine learning model, in the updated machine learning model, the accuracy of the output result from the machine learning model relative to the inspection result of an actually performed inspection becomes equal to or higher than the reference level. In the updating of the machine learning model, according to one or more of the large number of data sets used for retraining, an inspection result of a post-reflow inspection that has been actually performed is shown in the case where a determination result at the determination unit 32 differs from the result of the actually performed inspection. Therefore, the learning model update unit 35 retrains the machine learning model using an inspection result of a post-reflow inspection that has been actually performed in the case where a determination result at the determination unit 32 differs from the result of the actually performed inspection.

In one example, regarding to the case where the determination unit 32 has determined that defectiveness will not occur but the actual inspection result indicates that defectiveness has occurred, image data based on pre-reflow images and an inspection result of a post-reflow inspection that has been actually performed are shown in one or more of a large number of data sets. That is, regarding to the case where it has been newly found that defectiveness will occur in the inspection, the above-described image data and inspection result are shown in one or more of the data sets. In this case, in retraining, the machine learning model learns features of image data regarding to a data set showing image data and an inspection result in the case where it has been newly found that defectiveness will occur in the inspection. It is to be noted that the learning model update unit 35 need not be provided in the information processing apparatus 6. In one example, an update process of the above-described machine learning model is performed by a computer, etc. different from the information processing apparatus 6.

As described above, in the present embodiment, whether or not defectiveness will occur in a post-reflow inspection is determined from image data based on pre-reflow images acquired in real time, using a machine learning model that outputs an inspection result of the post-reflow inspection from an input of the image data based on the pre-reflow images. Thus, in manufacturing of a printed board by means of soldering, it is possible to detect defectiveness in the printed board manufactured as a product prior to joining of a component to the board, which is a substrate, by means of a reflow process.

Since defectiveness in an inspection to be performed after a reflow process can be detected prior to the reflow process, the occurrence of defective printed boards (products) is effectively suppressed, and the loss of members can be appropriately reduced. Moreover, since the occurrence of defective printed boards is suppressed, an increase in the number of steps for repairing the defective products, for example, is effectively suppressed in the manufacturing of the printed boards. Furthermore, since defectiveness can be detected prior to a reflow process, the cause of the defectiveness can be diagnosed from the state prior to joining of a component to a board, which is a substrate, by means of the reflow process. Thus, in diagnosing the cause of defectiveness, the loss of members is appropriately reduced, and an increase in the number of steps is effectively suppressed.

Also, in the present embodiment, image data based on pre-reflow images is input to the machine learning model, and whether or not defectiveness will occur in a post-reflow inspection is determined. Since the image data based on the pre-reflow images is used for input to the machine learning model, whether or not defectiveness will occur in the inspection is determined in view of variations among the post-reflow product-state printed boards and variations among the boards or printed boards in each step of the manufacturing process. Therefore, whether or not defectiveness will occur in a post-reflow inspection is determined more appropriately.

In the present embodiment, in generating of a machine learning model, a model is trained through deep learning using learning data in which image data based on pre-reflow images is associated with an inspection result of a post-reflow inspection that has been actually performed. Thus, a machine learning model that appropriately outputs, from an input of image data based on pre-reflow images, an inspection result at a post-reflow inspection is generated.

Also, in the present embodiment, in updating a machine learning model, the machine learning model is retrained using an inspection result of a post-reflow inspection that has been actually performed in the case where the determination result differs from the inspection result of the actually performed inspection. Since the machine learning model is updated as described above, a decrease in accuracy of a determination result relative to an inspection of an actually performed inspection is effectively suppressed.

In the example of FIG. 4, etc., positions of the above-described three types of pre-reflow images are adjusted with respect to one another, and different color information is appended to the three types of pre-reflow images. Image data to be input to the machine learning model is generated by adjusting the positions and appending color information, and then synthesizing the three types of images. If a synthesis image is input to the machine learning model, the complexity of the machine learning model is suppressed, and quickness of the processing at the machine learning model is improved. Thus, whether or not defectiveness will occur in a post-reflow inspection is determined more quickly.

In the example of FIG. 5, etc., the above-described three types of pre-reflow images are lined up, and image data to be input to the machine learning model is generated. In the case where image data configured of three types of images is input to the machine learning model, further detailed data analysis, etc. is performed on the machine learning model, and the appropriateness of the output result from the machine learning model is improved.

Therefore, whether or not defectiveness will occur in a post-reflow inspection is determined more appropriately.

### Second Embodiment

Next, a second embodiment will be described as a modification of the first embodiment. In the second embodiment, too, a manufacturing system 1 includes a solder printing apparatus 2, a component mounting apparatus 3, a reflow apparatus 4, an inspection apparatus 5, an information processing apparatus 6, and photographing apparatuses 11 to 13, and printed boards are manufactured as products by means of the solder printing apparatus 2, the component mounting apparatus 3, the reflow apparatus 4, and the inspection apparatus 5, similarly to the above-described embodiment, etc.

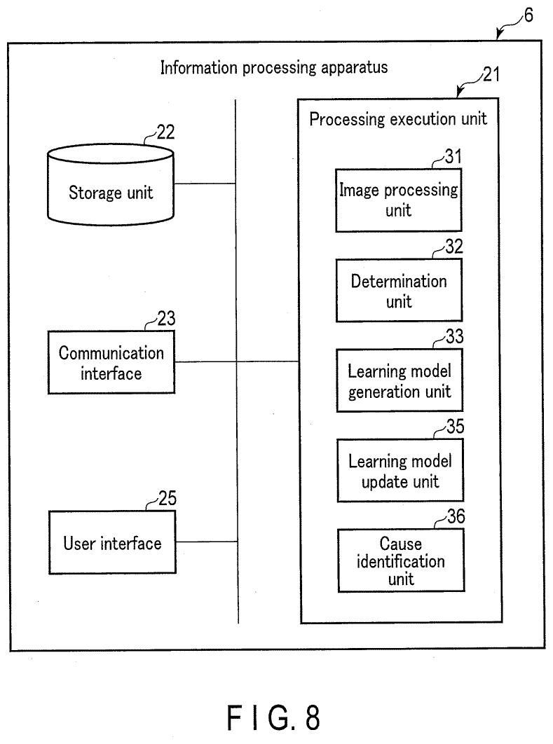

FIG. 8 shows an example of the information processing apparatus 6 according to the present embodiment. As shown in FIG. 8, etc., in the present embodiment, too, the information processing apparatus 6 includes a processing execution unit 21, a storage unit 22, a communication interface 23, and a user interface 25. The processing execution unit 21 includes an image processing unit 31, a determination unit 32, a learning model generation unit 33, and a learning model update unit 35. In the present embodiment, too, the photographing apparatuses 11 to 13 photograph images prior to the reflow process, similarly to the above-described embodiment, etc., and each of the image processing unit 31, the determination unit 32, the learning model generation unit 33, and the learning model update unit 35 performs processing similar to that in the above-described embodiment, etc.

In the present embodiment, the processing execution unit 21 further includes a cause identification unit 36, and the cause identification unit 36 performs part of the processing performed by the processing execution unit 21. If the determination unit 32 determines that defectiveness will occur in a post-reflow inspection, the cause identification unit 36 identifies the cause of the defectiveness. At this time, the cause identification unit 36 identifies, using Explainable Artificial Intelligence (XAI) technology, the cause of the defectiveness in the image data input to the machine learning model. Thereby, the cause of the defectiveness is identified in the image data based on the three types of pre-reflow images. In the case of identifying the cause of defectiveness as in the present embodiment, it is preferable that determination by the determination unit 32 be performed with image data in which three types of images are lined up, as shown in the example of FIG. 5, etc., being input to the machine learning model.

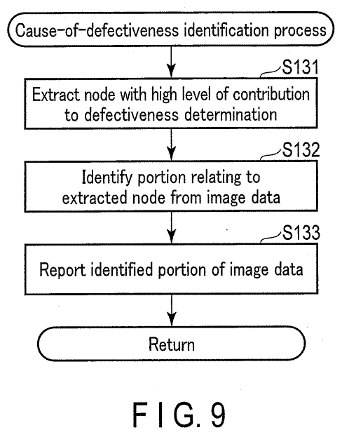

FIG. 9 shows an example of an identification process of the cause of the defectiveness by the cause identification unit 36. The processing in the example of FIG. 9 is performed if the determination unit 32 determines that defectiveness will occur in a post-reflow inspection. Upon starting of the processing in FIG. 9, the cause identification unit 36 extracts a node with a high level of contribution to the defectiveness determination from the intermediate layer 43 and the input layer 41 of the machine learning model (S131). That is, a node with a high level of contribution to an output result from a node that outputs information indicating that defectiveness will occur in the output layer 42 is extracted from the intermediate layer 43 and the input layer 41.

The cause identification unit 36 identifies, from the image data input to the machine learning model, a portion relating to the node extracted as a node with a high level of contribution to the defectiveness determination (S132). Thereby, the portion of the image data relating to the extracted node is identified as the cause of the defectiveness. The cause identification unit 36 causes the user interface 25, etc. to report the portion of the image data identified as the cause of the defectiveness (S133). At this time, in one example, the portion identified as the cause of the defectiveness is reported by, for example, displaying, in the image configuring the image data, the portion identified as the cause of the defectiveness in a color different from that of the other portions.

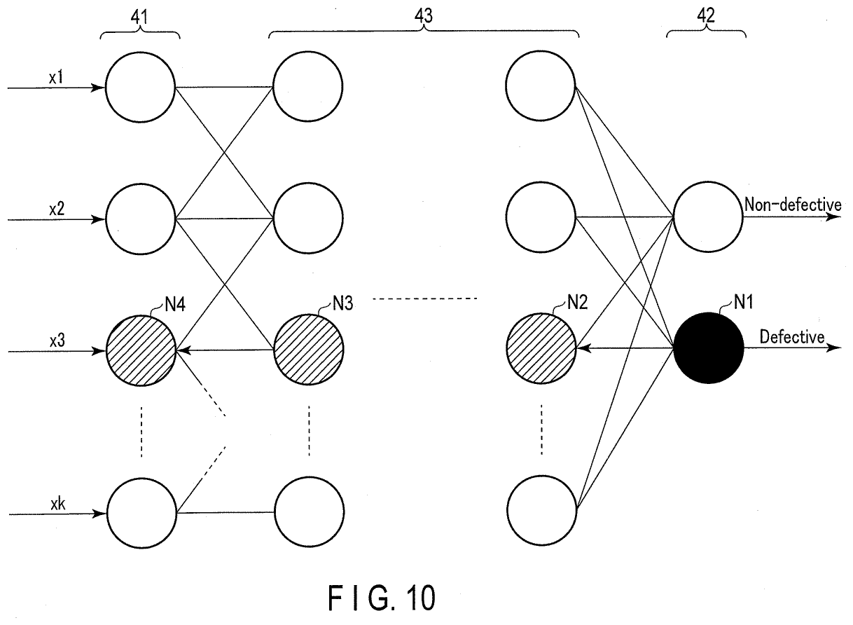

FIG. 10 illustrates an example of an extraction process of a node with a high level of contribution to the defectiveness determination performed by the cause identification unit 36. In the example of FIG. 10, a plurality of nodes including nodes N2 and N3 are extracted from the intermediate layer 43 as nodes with a high level of contribution to the output result from a node N1 that outputs information indicating that defectiveness will occur in the output layer 42. As a node with a high level of contribution to the output result from the node N1 that outputs the information indicating that defectiveness will occur in the output layer 42, a node N4 is extracted from the input layer 41. In the image data input to the machine learning model, namely, in one or more of the three types of pre-reflow images configuring the image data, the portion relating to the node N4 is identified as the cause of the defectiveness, and the portion corresponding to a pixel of pixel information x3 is identified as the cause of the defectiveness. In FIG. 10, the node N1 that outputs the information indicating that defectiveness will occur is shown in black, and nodes N2 to N4 extracted as nodes with a high level of contribution to the defectiveness determination are shown by diagonal hatching.

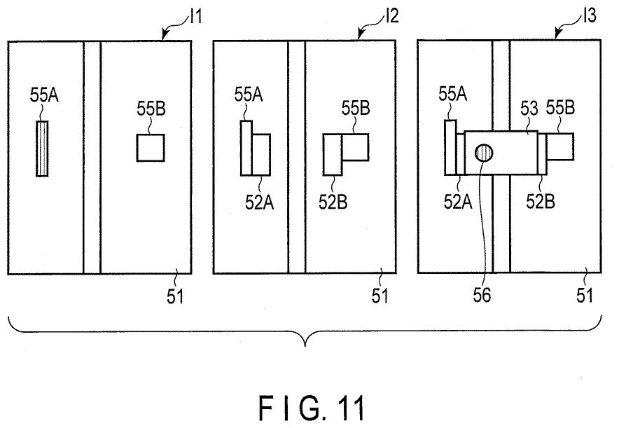

FIG. 11 illustrates an example of a reporting process of a portion identified as the cause of the defectiveness in the image data, performed by the cause identification unit 36. In the example of FIG. 11, image data to be input to the machine learning model is generated by lining up three types of pre-reflow images I1 to I3, namely, an image I1 showing only a board 51, which is a substrate, an image I2 showing the board 51 on which only solder 52A and solder 52B are mounted, and an image I3 showing the board 51 on which the solder 52A, the solder 52B, and a component 53 are mounted. In the example of FIG. 11, pads 55A and 55B are formed on the board 51, and the component 53 is an LED chip including an LED 56.

In the example of FIG. 11, to report the portion identified as the cause of the defectiveness, the cause identification unit 36 causes the user interface 25, etc. to display the three types of images I1 to I3 configuring image data to be input to the machine learning model. The cause identification unit 36 causes the portion identified as the cause of the defectiveness in the images I1 to I3 to be displayed in red. In the example of FIG. 11, the pad 55A in the image I1 showing only the board 51 and the LED 56 of the component 53 in the image I3 showing the board 51 on which the solder 52A, the solder 52B, and the component 53 are mounted are displayed in red. The user, etc. of the manufacturing system 1 recognizes, based on the images I1 to I3 displayed as in the example of FIG. 11 as an identification result of the cause of the defectiveness, that the small width of the pad 55A formed on the board 51 and the deviation from a proper position of the position at which the component 53 is mounted by the component mounting apparatus 3 are the causes of the defectiveness determination.

In the present embodiment, too, whether or not defectiveness will occur in a post-reflow inspection is determined from image data based on pre-reflow images acquired in real time, using a machine learning model that outputs an inspection result of a post-reflow inspection from an input of image data based on pre-reflow images. Thus, in the present embodiment, in manufacturing of a printed board by means of soldering, it is possible to detect a defect in the printed board manufactured as a product prior to joining of a component to the board, which is a substrate, by means of a reflow process, similarly to the first embodiment. Therefore, the present embodiment produces advantageous effects similar to those of the first embodiment, etc.

In the present embodiment, if it is determined that defectiveness will occur in a post-reflow inspection, the cause of the defectiveness is identified in image data based on pre-reflow images. This allows the user, etc. of the manufacturing system 1 to recognize which portion of which step in the pre-reflow processing has become the cause of the defectiveness. That is, since the above-described processing in which the cause of the determined defectiveness is identified is performed by the information processing apparatus 6, it is possible to find the cause of the defectiveness quickly and appropriately.

### Modifications of First and Second Embodiments

In the above-described embodiments, image data to be input to the machine learning model is generated by three types of images, namely, an image showing only a board, which is a substrate, an image showing the board on which only solder is mounted, and an image showing the board on which the solder and the component are mounted; however, it is not limited thereto. In a modification, only two of the above-described three types of pre-reflow images are used to generate image data to be input to the machine learning model. In this case, in one example, image data to be input to the machine learning model is generated using two types of images, namely, an image showing only a board and an image showing the board on which solder and a component are mounted, and in another example, image data to be input to the machine learning model is generated using two types of images, namely, an image showing a board on which only solder is mounted and an image showing the board on which the solder and a component are mounted.

Therefore, in the embodiments, etc., it suffices that image data to be input to the machine learning model is generated using, as pre-reflow images, two or more types of images of the three types of images. In this case, in one example, similarly to the example of FIG. 4, etc., positions of the two or more types of images are adjusted with respect to one another, and different color information is appended to the two or more types of images. Image data to be input to the machine learning model is generated by adjusting the positions and appending color information, and then synthesizing the two or more types of images. In another example, similarly to the example of FIG. 5, etc., by lining up two or more types of images, image data to be input to the machine learning model is generated.

### Third Embodiment

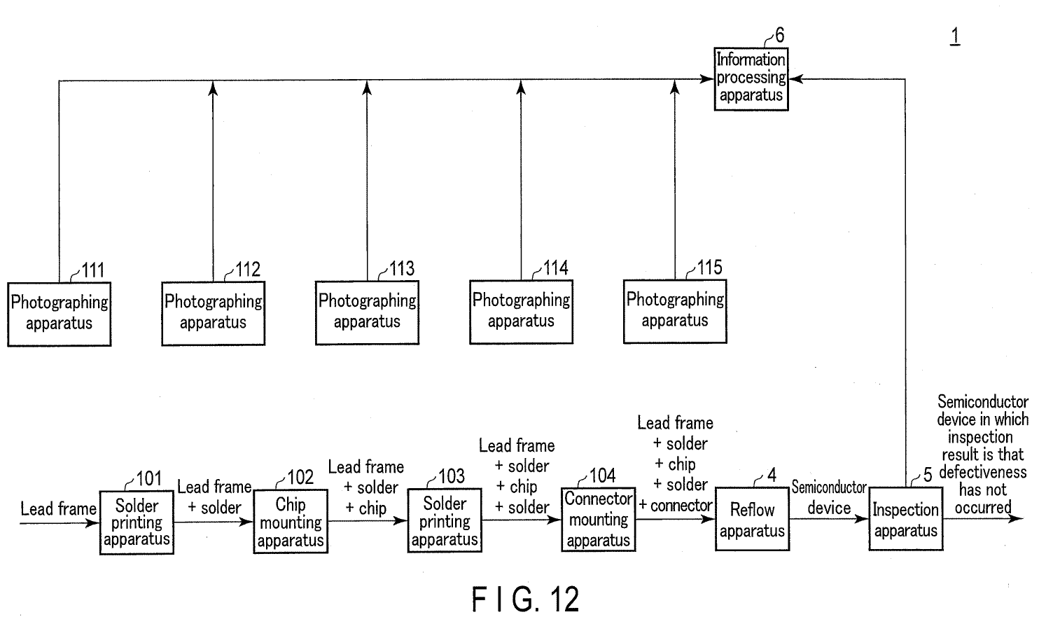

Next, a third embodiment will be described as a modification of the first embodiment, etc. FIG. 12 shows a manufacturing system 1 according to the third embodiment, as an example of a manufacturing system in which semiconductor devices are manufactured as products. As shown in FIG. 12, etc., the manufacturing system 1 according to the embodiment includes, similarly to the above-described embodiments, a reflow apparatus 4, an inspection apparatus 5, and an information processing apparatus 6. In the manufacturing system 1 according to the present embodiment, however, a solder printing apparatus 101, a chip mounting apparatus 102, a solder printing apparatus 103, and a connector mounting apparatus 104 are provided, in place of the solder printing apparatus 2 and the component mounting apparatus 3. In the manufacturing system 1 according to the present embodiment, a manufacturing line of semiconductor devices, which are products, is formed, and the solder printing apparatus 101, the chip mounting apparatus 102, the solder printing apparatus 103, the connector mounting apparatus 104, the reflow apparatus 4, and the inspection apparatus 5 are arranged in this order from the upstream side in the manufacturing line.

In the manufacturing line, a lead frame, which is a substrate, is conveyed to the solder printing apparatus 101. The solder printing apparatus 101 mounts solder onto a lead frame by printing, for example, solder onto a surface of the lead frame. At this time, room-temperature solder is mounted onto the lead frame, namely, solder is mounted onto the lead frame in a non-melted state. A method of mounting solder onto the lead frame is not limited to printing, and solder may be mounted onto the lead frame by either dispensing (applying) solder thereto or mounting a solder sheet thereon.

The lead frame on which the solder is mounted is conveyed to the chip mounting apparatus 102. The chip mounting apparatus 102 mounts a chip as a component to be newly attached onto the lead frame. Through the mounting of the chip, the solder mounted by the solder printing apparatus 101 is interposed between the lead frame, which is a substrate, and the chip, which is a component.

The lead frame on which the solder and the chip are mounted is conveyed to the solder printing apparatus 103. The solder printing apparatus 103 mounts solder onto the lead frame and the chip by, for example, printing solder onto a surface of the lead frame and a surface of the chip. At this time, room-temperature solder is mounted onto the lead frame and the chip, namely, solder is mounted onto the lead frame and the chip in a non-melted state. A method of mounting solder onto the lead frame and the chip is not limited to printing, and solder may be mounted onto the lead frame and the chip by either dispensing (applying) solder thereto or mounting a solder sheet thereon.

The lead frame and the chip on which the solder is mounted in the solder printing apparatus 103 are conveyed to the connector mounting apparatus 104. The connector mounting apparatus 104 mounts a connector as a component to be newly attached onto the lead frame and the chip. The connector is a component mounted on the lead frame, and is a component separate from the chip. Through the mounting of the connector, the solder mounted by the solder printing apparatus 103 is interposed between the lead frame and the connector, or between the chip and the connector.

In the present embodiment, a lead frame on which the chip and the connector, which are components, and the solder are mounted is conveyed to the reflow apparatus 4. In the present embodiment, too, the reflow apparatus 4 performs soldering by means of a reflow process. Through the reflow process, the solder mounted by the solder printing apparatuses 101 and 103, etc. is melted. The chip, which is a newly mounted component, is joined to the lead frame, and the connector, which is a newly mounted component, is joined to the lead frame and the chip. Thereby, a semiconductor device in which components such as a chip and a connector mounted thereon are attached to a lead frame, which is a substrate, is formed.

A semiconductor device manufactured as a product, namely, a semiconductor device obtained by joining components such as a chip and a connector to a lead frame, which is a substrate, by means of a reflow process in the reflow apparatus 4 is conveyed to the inspection apparatus 5. The inspection apparatus 5 inspects the manufactured semiconductor device, and determines whether the manufactured semiconductor device is non-defective or defective. Through the inspection by the inspection apparatus 5, only semiconductor devices determined to be non-defective are distributed to the market as distribution products. The inspection apparatus 5 performs, for example, a visual inspection, an electricity test, etc. on the manufactured semiconductor device. The visual inspection, the electricity test, etc. are performed as described above.

In the manufacturing system 1 according to the present embodiment, photographing apparatuses 111 to 115, which are cameras, or video cameras, or the like are provided. The photographing apparatus 111 is arranged on an upstream side relative to the solder printing apparatus 101, and photographs a first image showing only a lead frame, which is a substrate. The photographing apparatus 112 is arranged between the solder printing apparatus 101 and the chip mounting apparatus 102, and photographs a second image showing a lead frame on which only solder is mounted. The photographing apparatus 113 is arranged between the chip mounting apparatus 102 and the solder printing apparatus 103, and photographs a third image showing the lead frame on which a chip, which is a component, is further mounted, relative to the state of the second image. The photographing apparatus 114 is arranged between the solder printing apparatus 103 and the connector mounting apparatus 104, and photographs a fourth image showing the lead frame and the chip on which solder is further mounted, relative to the state of the third image. The photographing apparatus 115 is arranged between the connector mounting apparatus 104 and the reflow apparatus 4, and photographs a fifth image showing the lead frame and the chip on which a connector, which is a component separate from the chip, is further mounted, relative to the state of the fourth image.

Therefore, in the manufacturing system 1 according to the present embodiment, five types of images, namely, first to fifth images, are photographed by the photographing apparatuses 111 to 115 as images prior to a reflow process to be performed by the reflow apparatus 4. Each of the photographing apparatuses 111 to 115 sends the photographed image (image data) to the information processing apparatus 6. The information processing apparatus 6 acquires images photographed by the photographing apparatus 111 to 115 in a manner similar to acquiring the photographed images photographed by the photographing apparatuses 11 to 13 in the above-described embodiments, etc. Thus, every time a single lead frame is conveyed to the manufacturing line, the information processing apparatus 6 acquires, in real time, first to fifth images as five types of pre-reflow images photographed by the photographing apparatuses 111 to 115.

In the present embodiment, the information processing apparatus 6 includes, similarly to the first embodiment, etc., a processing execution unit 21, a storage unit 22, a communication interface 23, and a user interface 25 (see FIG. 2). The processing execution unit 21 includes an image processing unit 31, a determination unit 32, a learning model generation unit 33, and a learning model update unit 35.

In the present embodiment, too, the image processing unit 31 performs image processing as pre-processing of the processing in the determination unit 32, similarly to the above-described embodiment, etc. However, in the present embodiment, the image processing unit 31 performs image processing using, as pre-reflow images, the above-described five types of images, namely, the first to fifth images. By performing the image processing, the image processing unit 31 generates, as image data used for the processing in the determination unit 32, image data based on the five types of pre-reflow images. Also, the image processing unit 31 generates, every time a single lead frame is conveyed to the manufacturing line, image data based on the five types of pre-reflow images acquired in real time.

In one example, similarly to the example of FIG. 4, etc., the image processing unit 31 generates image data used in the processing in the determination unit 32 by adjusting the positions of the five types of pre-reflow images and appending different color information to the five types of images, and then synthesizing the five types of images. In another example, image data used for processing in the determination unit 32 is generated by lining up five types of pre-reflow images.

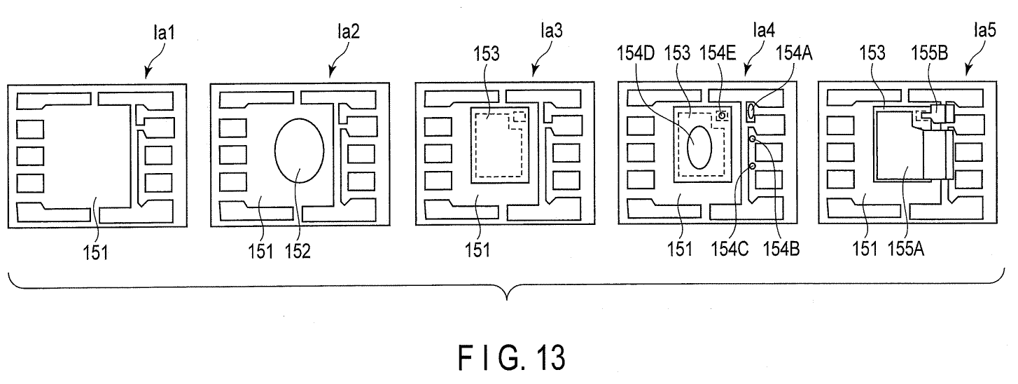

FIG. 13 shows an example of image data generated by image processing in the image processing unit 31 according to the present embodiment. In the example of FIG. 13, image data used for processing in the determination unit 32 is generated by lining up five types of pre-reflow images, namely, a first image Ia1, a second image Ia2, a third image Ia3, a fourth image Ia4, and a fifth image Ia5. In the first image Ia1, only the lead frame 151, which is a substrate, is shown. The second image Ia2 shows the lead frame 151 on which only solder 152 is mounted. The third image Ia3 shows, relative to the state of the second image Ia2, the lead frame 151 on which the chip 153, which is a component, is mounted. The fourth image Ia4 shows, relative to the state of the third image Ia3, the lead frame 151 on which the solder 154A, the solder 154B, and the solder 154C are further mounted, and the chip 153 on which the solder 154D and the solder 154E are further mounted. The fifth image Ia5 shows, relative to the state of the fourth image Ia4, the lead frame 151 and the chip 153 on which connectors 155A and 155B, which are components separate from the chip 153, are mounted.

In the present embodiment, the determination unit 32 determines, using the machine learning model stored in the storage unit 22, etc., whether or not defectiveness will occur in a post-reflow inspection to be performed at the inspection apparatus 5, based on the above-described image data generated by the image processing unit 31. Therefore, in the present embodiment, too, the determination unit 32 determines whether or not defectiveness will occur in the post-reflow inspection, from the image data based on the pre-reflow images acquired in real time. In the present embodiment, too, the determination unit 32 causes the machine learning model to input the image data generated by the image processing unit 31. The determination unit 32 causes the machine learning model to output information indicating whether or not defectiveness will occur in the inspection, and makes a result of the output from the machine learning model a determination result regarding whether or not defectiveness will occur in the inspection.

In the present embodiment, too, the machine learning model used for determination by the determination unit 32 is configured of an input layer 41, an output layer 42, and an intermediate layer (hidden layer) 43 between the input layer 41 and the output layer 42. If the above-described image data is input to the machine learning model, pixel-by-pixel pixel information, such as RGB values, is input to the input layer 41 regarding to all the images configuring the image data. In the machine learning model, the output layer 42 is configured of a node that outputs information indicating that defectiveness will not occur in an inspection, and a node that outputs information indicating that defectiveness will occur in the inspection, similarly to the above-described embodiments, etc. Also, the intermediate layer 43 is configured of a plurality of convolutional layers, a plurality of pooling layers, a fully connected layer, etc., similarly to the above-described embodiments, etc.

In the present embodiment, the machine learning model used for determination in the determination unit 32 is generated (constructed) by the learning model generation unit 33 using learning data configured of a large number of data sets, similarly to the above-described embodiments, etc. In the present embodiment, in each of the data sets of the learning data, image data based on the above-described five types of pre-reflow images is shown for a semiconductor device on which an inspection has been previously performed. In the present embodiment, the learning model update unit 35 updates the machine learning model by retraining the machine learning model, similarly to the above-described embodiments.

In the present embodiment, too, whether or not defectiveness will occur in a post-reflow inspection is determined from image data based on pre-reflow images acquired in real time, using a machine learning model that outputs an inspection result of a post-reflow inspection from an input of image data based on pre-reflow images. Thus, in manufacturing of a semiconductor device by means of soldering, it is possible to detect defectiveness in the semiconductor device manufactured as a product prior to joining of components such as a chip and a connector to a lead frame, which is a substrate, by means of a reflow process. As described above, according to the present embodiment in which semiconductor devices are manufactured as products by means of soldering, an advantageous effect similar to the above-described embodiment, etc., in which printed boards are manufactured by means of soldering, can be achieved.

### Modifications of Third Embodiment

In a modification of the third embodiment, etc., in the manufacturing system 1 in which semiconductor devices are manufactured as products as described above, the processing execution unit 21 of the information processing apparatus 6 further includes a cause identification unit 36, similarly to the second embodiment. If the determination unit 32 determines that defectiveness will occur in a post-reflow inspection, the cause identification unit 36 identifies the cause of the defectiveness, similarly to the second embodiment, etc. At this time, the cause identification unit 36 identifies, using Explainable Artificial Intelligence (XAI) technology, the cause of the defectiveness in the image data input to the machine learning model. Thereby, the cause of the defectiveness is identified in the image data based on the five types of pre-reflow images.

In the present modification, similarly to the second embodiment, etc., upon determining, by the determination unit 32, that defectiveness will occur in a post-reflow inspection, the cause identification unit 36 extracts a node with a high level of contribution to the defectiveness determination from the intermediate layer 43 and the input layer 41 in the machine learning model. The cause identification unit 36 identifies, from the image data input to the machine learning model, a portion relating to the node extracted as a node with a high level of contribution to the defectiveness determination. Thereby, the portion of the image data relating to the extracted node is identified as the cause of the defectiveness. In the present modification, too, the cause identification unit 36 causes the user interface 25, etc. to report the portion of the image data identified as the cause of the defectiveness.

In the present modification, too, whether or not defectiveness will occur in a post-reflow inspection is determined from image data based on pre-reflow images acquired in real time, using a machine learning model that outputs an inspection result of a post-reflow inspection from an input of image data based on pre-reflow images. Thus, in the present modification, too, similarly to the third embodiment, etc., in manufacturing of a semiconductor device by means of soldering, it is possible to detect defectiveness in the semiconductor device manufactured as a product prior to joining of components such as a chip and a connector onto a lead frame, which is a substrate, by means of a reflow process. Therefore, the present modification produces advantageous effects similar to those of the above-described embodiments, etc.

In the present modification, if it is determined that defectiveness will occur in a post-reflow inspection, the cause of the defectiveness is identified in image data based on pre-reflow images. This allows the user, etc. of the manufacturing system 1 to recognize which portion of which step in the pre-reflow processing has become the cause of the defectiveness, similarly to the second embodiment, etc. That is, since the above-described processing in which the cause of the determined defectiveness is identified is performed by the information processing apparatus 6, it is possible to find the cause of the defectiveness quickly and appropriately.

In the above-described third embodiment and its modifications, image data to be input to the machine learning model is generated using five types of pre-reflow images; namely, the first to five images. In a modification, in manufacturing of semiconductor devices, wire bonding is performed, in place of the mounting of a connector as a component. In this case, in the manufacturing system 1 in which semiconductor devices are manufactured, the solder printing apparatus 103 and the connector mounting apparatus 104 are not provided. In the present modification, after solder is mounted onto a lead frame by the solder printing apparatus 101 and a chip is mounted onto a lead frame by the chip mounting apparatus 102, a reflow process to be performed by the reflow apparatus 4 is performed without mounting a connector, etc.

Since semiconductor devices are manufactured as described above, in the present modification, only photographing apparatuses 111 to 113 are provided, and photographing apparatuses 114 and 115 are not provided. Therefore, in the present modification, only three types of images, namely, first to third images are photographed as pre-reflow images, and fourth and fifth images are not photographed. In the present modification, image data to be input to the machine learning model is generated using three types of images, namely, first to third images as pre-reflow images. Therefore, in the third embodiment and its modification, etc., it suffices that image data to be input to the machine learning model is generated using, as pre-reflow images, two or more types of images of the five types of images, namely, the first to fifth images.

### Other Modifications

In another modification, whether or not defectiveness will occur in a post-reflow inspection is determined based on information indicating reflow conditions, in addition to the image data based on the pre-reflow images. In this case, too, whether or not defectiveness will occur in an inspection is determined using the above-described machine learning model, similarly to the above-described embodiments, etc. The information indicating the reflow conditions includes specification information of the reflow apparatus 4 and an environmental temperature, etc. of an environment under which a reflow process is performed.

In another modification, in addition to image data based on pre-reflow images, solder thickness information may be input to the machine learning model. In addition to the above-described image data based on the pre-reflow images, position information regarding a height direction (a thickness direction of the substrate, the solder, and the component) in each of the pre-reflow images may be input to the machine learning model. The position information regarding a height direction in each of the pre-reflow images indicates, for example, an image, etc. of a height distribution in each of the pre-reflow images. In the present modification, too, whether or not defectiveness will occur in an inspection is determined using the above- described machine learning model, similarly to the above-described embodiments, etc.

According to at least one of the embodiments or examples, whether or not defectiveness will occur in a post-reflow inspection is determined from image data based on pre-reflow images acquired in real time, using a machine learning model that outputs an inspection result of a post-reflow inspection from an input of image data based on pre-reflow images. It is thereby possible, in manufacturing of products by means of soldering, to provide an information processing apparatus and an information processing method capable of detecting defectiveness in the manufactured products prior to joining of a component to a substrate by means of a reflow process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus relating to soldering of a component onto a substrate, comprising:
a determination unit configured to determine, from image data based on one or more images prior to a reflow process acquired in real time, whether or not defectiveness will occur in an inspection to be performed after the reflow process, using a machine learning model that outputs an inspection result of the inspection to be performed after the reflow process from an input of the image data based on the images prior to the reflow process.

2. The information processing apparatus according to claim 1, further comprising:
a cause identification unit configured to identify, if the determination unit has determined that defectiveness will occur in the inspection to be performed after the reflow process, a cause of the defectiveness in the image data based on the images prior to the reflow process.

3. The information processing apparatus according to claim 2, wherein
the cause identification unit extracts a node with a high level of contribution to the determination of the defectiveness from the machine learning model, and
the cause identification unit identifies, in the image data based on the images prior to the reflow process, a portion relating to the extracted node as the cause of the defectiveness.

4. The information processing apparatus according to claim 1, further comprising:
a learning model generation unit configured to generate the machine learning model by training a model through deep learning using learning data in which the image data based on the images prior to the reflow process and the inspection result of the inspection that has been actually performed after the reflow process are associated.

5. The information processing apparatus according to claim 1, further comprising:
a learning model update unit configured to update the machine learning model by retraining the machine learning model using the inspection result of the inspection that has been actually performed after the reflow process in a case where a determination result in the determination unit differs from the inspection result of the inspection that has been actually performed after the reflow process.

6. The information processing apparatus according to claim 1, further comprising:
an image processing unit configured to generate the image data to be input to the machine learning model by using a plurality of types of images as the images prior to the reflow process.

7. The information processing apparatus according to claim 6, wherein
the image processing unit generates the image data to be input to the machine learning model by lining up the plurality of types of images.

8. The information processing apparatus according to claim 6, wherein
the image processing unit adjusts positions of the plurality of types of images with respect to one another, and appends different color information to the plurality of types of images, and
the image processing unit generates the image data to be input to the machine learning model by synthesizing the plurality of types of images after the adjusting of the positions and the appending of the color information.

9. The information processing apparatus according to claim 6, wherein
the image processing unit uses, for generation of the image data to be input to the machine learning model, two or more types of images of three types of images, the three types of images including: an image showing only a board, which is the substrate; an image showing the board on which only solder is mounted; and an image showing the board on which the solder and the component are mounted.

10. The information processing apparatus according to claim 6, wherein
the image processing unit uses, for generation of the image data to be input to the machine learning model, two or more types of images of five types of images, the five types of images including: a first image showing only a lead frame, which is the substrate; a second image showing the lead frame on which only solder is mounted; a third image showing the lead frame on which a chip, which is the component, is further mounted, relative to a state of the second image; a fourth image showing the lead frame and the chip on which solder is further mounted, relative to a state of the third image; and a fifth image showing the lead frame and the chip on which a connector, which is a component different from the chip, is further mounted, relative to a state of the fourth image.

11. An information processing method relating to soldering of a component onto a substrate, comprising:
determining, from image data based on one or more images prior to a reflow process acquired in real time, whether or not defectiveness will occur in an inspection to be performed after the reflow process, using a machine learning model that outputs an inspection result of the inspection to be performed after the reflow process from an input of the image data based on the images prior to the reflow process.
